(19) United States
(12) Patent Application Publication
(10) Pub. No.: US 2025/0137306 A1
(43) Pub. Date: May 1, 2025

(54) SCORE BOARD FOR COMPETITION AND HINGE GROUP THEREOF

(71) Applicant: XIAMEN CHENKE INDUSTRIAL CO., LTD, Xiamen (CN)

(72) Inventor: Lili Wang, Xiamen (CN)

(21) Appl. No.: 18/917,955

(22) Filed: Oct. 16, 2024

(30) Foreign Application Priority Data
Oct. 26, 2023 (CN) 202322884769.1

(51) Int. Cl. E05D 3/06; E05D 5/12

(52) U.S. Cl. CPC E05D 3/06; E05D 5/12; E05Y 2900/00

(57) ABSTRACT

The present disclosure discloses a score board for a competition and a hinge group thereof. The score board includes a first box and a second box which are connected through a hinge group, the hinge group includes an upper hinge and a lower hinge, the upper hinge and the lower hinge are mutually hinged together, the upper hinge is hinged to the first box, the upper hinge is slidably disposed on the second box, and the lower hinge is slidably disposed on the first box. When the first box and the second box are unfolded, display screens on front surfaces of the first box and the second box can be used to display scores of the competition.

### CROSS REFERENCE TO RELATED APPLICATIONS

The present application claims the benefit of Chinese Patent Application No. 202322884769.1 filed on Oct. 26, 2023, the contents of which are incorporated herein by reference in their entirety.

### FIELD

The present disclosure relates to the technical field of competition scoring devices, in particular to a score board for a competition and a hinge group thereof.

### BACKGROUND OF THE INVENTION

Sports competitions not only appear in various large-scale competition sites, but also being spontaneously organized frequently in our daily lives, so as to take actions to practice physical fitness. Proper scoring while following rules during competitions can increase the motivation of each competitor and improve quality of the competitions.

A traditional scoring manner for the competitions mostly uses a simple scoring board, and the scoring board is manually flipped to score. This scoring manner requires personnel to supervise and control scoring throughout a competition during, which takes up too much manpower and is prone to making an error. When large data is recorded, the scoring board needs to be replaced, making an operation more complicated. In addition, a score board used to support the scoring board has a large volume, resulting in a large overall structure, inconvenient carrying and storage, and occupation of a lot of space. Moreover, a traditional scoring device has poor stability. When encountering strong wind blowing on the score board during outdoor use, a support frame will shake, causing the score board to break and affect the scoring of the competitions, and it is also inconvenient to transport and store the score board separately from a bracket.

In view of this, a designer has deeply considered many deficiencies and inconveniences caused by imperfect structure design of an existing competition score board, and actively researched and improved the trial production to develop the present disclosure.

### SUMMARY OF THE INVENTION

An objective of the present disclosure is to overcome shortcomings of the prior art and provide a score board for a competition which is stable in structure and convenient to carry and store.

For achieving the above objective, the technical solution adopted by the present disclosure is as follows:

A score board for a competition includes at least two boxes, the two adjacent boxes are respectively connected through a hinge group, the two adjacent boxes include a first box and a second box, the hinge group includes an upper hinge and a lower hinge, the upper hinge and the lower hinge are respectively provided with first shaft holes, second shaft holes and shaft rods, the first shaft holes of the upper hinge and the lower hinge are mutually hinged together through a first rotating shaft, the second shaft hole of the upper hinge is hinged to the first box through a second rotating shaft, the shaft rod of the upper hinge is slidably disposed on the second box, the second shaft hole of a lower hinge is hinged to the second box through a third rotating shaft, the shaft rod of the lower hinge is slidably disposed on the first box, a back surface of the first box is provided with a first mounting groove corresponding to the lower hinge, and the first mounting groove is internally provided with a first movable groove for allowing the shaft rod of the lower hinge to move; and a back surface of the second box is provided with a second mounting groove corresponding to the upper hinge, the second mounting groove is internally provided with a second movable groove for allowing the shaft rod of the upper hinge to move, and surfaces of the first box and the second box are provided with display screens.

Further, the first mounting groove of the first box is provided with a first clamping buckle platform for limiting the shaft rod of the lower hinge, and the second mounting groove of the second box is provided with a second clamping buckle platform for limiting the shaft rod of the upper hinge.

Further, the first box and the second box are internally and respectively provided with wiring spaces, and the upper hinge and the lower hinge are provided with receding grooves for allowing electric wires to penetrate through.

Further, the upper hinge and the lower hinge have the same structure, the upper hinge and the lower hinge are respectively L-shaped structures with a first connecting plate and a second connecting plate, the first shaft hole of the upper hinge and the first shaft hole of the lower hinge are formed in a connection between the first connecting plate and the second connecting plate, and the second shaft hole of the upper hinge and the second shaft hole of the lower hinge are respectively formed at an end of the second connecting plate; and the shaft rod of the upper hinge and the shaft rod of the lower hinge are respectively disposed at an end of the first connecting plate.

Further, the first connecting plate and the second connecting plate are disposed at an obtuse angle, a length of the first connecting plate is greater than a length of the second connecting plate, and an included angle between the first connecting plate and the second connecting plate is in circular arc transition.

Another objective of the present disclosure is to provide a hinge group that can connect two adjacent objects, so that the two objects can rotate relatively.

For achieving the above objective, the technical solution adopted by the present disclosure is as follows:

A hinge group is configured to connect a first box with a second box, the hinge group includes an upper hinge and a lower hinge, the upper hinge and the lower hinge are respectively provided with first shaft holes, second shaft holes and shaft rods, the first shaft holes of the upper hinge and the lower hinge are mutually hinged together through a first rotating shaft, the second shaft hole of the upper hinge is hinged to the first box through a second rotating shaft, the shaft rod of the upper hinge is slidably disposed on the second box, the second shaft hole of a lower hinge is hinged to the second box through a third rotating shaft, and the shaft rod of the lower hinge is slidably disposed on the first box. A relative rotation connection between the first box and the second box can be achieved through cooperation of the upper hinge and the lower hinge.

Further, the upper hinge and the lower hinge have the same structure, the upper hinge and the lower hinge are respectively L-shaped structures with a first connecting plate and a second connecting plate, the first shaft hole of the upper hinge and the first shaft hole of the lower hinge are formed in a connection between the first connecting plate and the second connecting plate, and the second shaft hole of the upper hinge and the second shaft hole of the lower hinge are respectively formed at an end of the second connecting plate; and the shaft rod of the upper hinge and the shaft rod of the lower hinge are respectively disposed at an end of the first connecting plate.

Further, the first connecting plate and the second connecting plate are disposed at an obtuse angle, a length of the first connecting plate is greater than a length of the second connecting plate, and an included angle between the first connecting plate and the second connecting plate is in circular arc transition.

After adopting the above structure, the score board for the competition of the present disclosure connects the first box with the second box through the hinge group, the upper hinge and the lower hinge of the hinge group are mutually hinged together and respectively connected with the first box and the second box at the same time. When the first box and the second box are relatively unfolded or folded, the shaft rods of the upper hinge and the lower hinge respectively move along the first movable groove and the second movable groove of the first box and the second box, so as to achieve unfolding and folding actions of the first box and the second box. When the first box and the second box are unfolded, display screens on the front surfaces of the first box and the second box can be used to display scores of the competition. When the first box and the second box are folded together through the hinge group, the volume can be reduced, and storage and transportation are facilitated. The score board for the competition of the present disclosure can be used for scoring in various competitions. Compared with a traditional scoring manner by flipping the board, the present disclosure can omit a manual board flipping action, and make a scoring result more stable and reliable.

### BRIEF DESCRIPTION OF DRAWINGS

FIG. 1 is a three-dimensional exploded view of a back surface of the present disclosure.

FIG. 2 is a three-dimensional exploded view of a front surface of the present disclosure.

FIG. 3 is a combination stereogram of a back surface of the present disclosure.

FIG. 4 is a combination stereogram of a front surface of the present disclosure.

FIG. 5 is a first schematic structural diagram of a hinge of the present disclosure.

FIG. 6 is a second schematic structural diagram of a hinge of the present disclosure.

### DETAILED DESCRIPTION OF THE INVENTION

In order to further explain the technical solution of the present disclosure, the present disclosure will be elaborated below in detail through specific embodiments.

In the description of the present disclosure, it should be understood that orientation or position relationships indicated by terms “center”, “longitudinal”, “transverse”, “upper”, “lower”, “front”, “back”, “left”, “right”, “vertical”, “horizontal”, “top”, “bottom”, “inside”, “outside”, etc. are orientation or position relationships shown on the basis of accompanying drawings, are only for the convenience of describing the present disclosure and simplifying the description, do not indicate or imply that the device or element referred to must have a specific orientation, and be constructed and operated in a specific orientation, and therefore cannot be understood as a limitation to the present disclosure. In the description of the present disclosure, unless otherwise noted, the meaning of “a plurality of” is two or more.

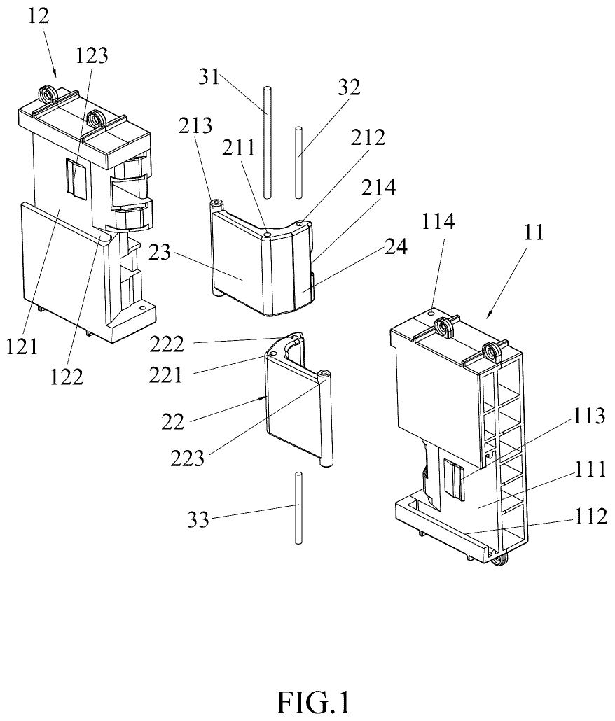

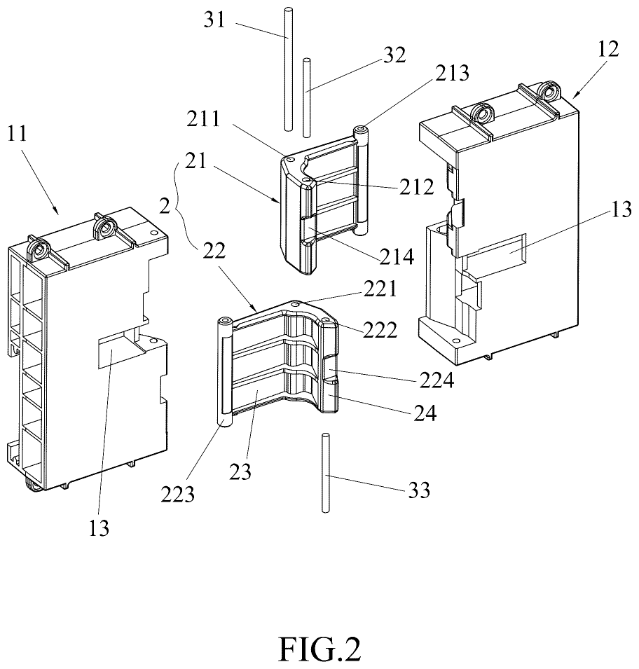

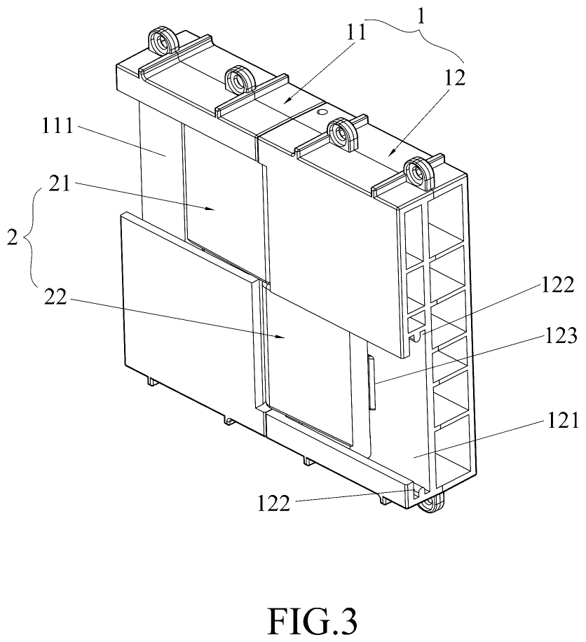

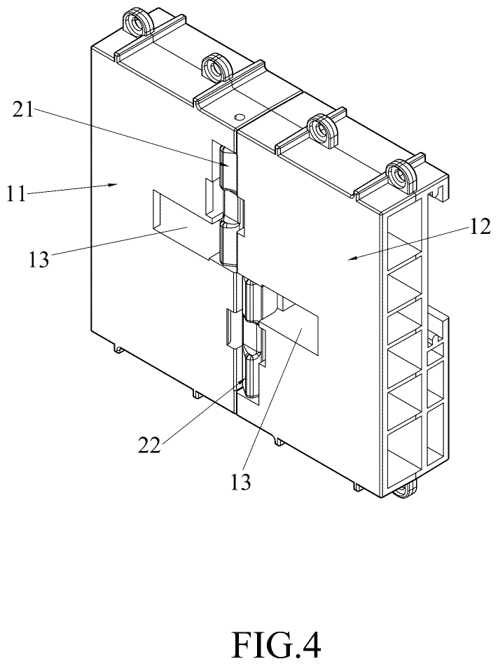

As shown in FIG. 1 to FIG. 6, the present disclosure discloses a score board for a competition, including at least two boxes 1, the two adjacent boxes 1 are respectively connected through a hinge group 2, the two adjacent boxes 1 include a first box 11 and a second box, the hinge group 2 includes an upper hinge 21 and a lower hinge 22, the upper hinge 21 and the lower hinge 22 are respectively provided with first shaft holes 211 and 221, second shaft holes 212 and 222 and shaft rods 213 and 223, the first shaft holes 211 and 221 of the upper hinge 21 and the lower hinge 22 are mutually hinged together through a first rotating shaft 31, the second shaft hole 212 of the upper hinge 21 is hinged to the first box 11 through a second rotating shaft 32, the shaft rod 213 of the upper hinge 21 is slidably disposed on the second box 12, the second shaft hole 222 of a lower hinge 22 is hinged to the second box 12 through a third rotating shaft 33, the shaft rod 223 of the lower hinge 22 is slidably disposed on the first box 12, a back surface of the first box 11 is provided with a first mounting groove 111 corresponding to the lower hinge 22, and the first mounting groove 111 is internally provided with a first movable groove 112 for allowing the shaft rod 223 of the lower hinge 22 to move; and a back surface of the second box 12 is provided with a second mounting groove 121 corresponding to the upper hinge 21, the second mounting groove 121 is internally provided with a second movable groove 122 for allowing the shaft rod 213 of the upper hinge 21 to move, and surfaces of the first box 11 and the second box are provided with display screens 13 for displaying scores of the competition.

The present disclosure connects the first box 11 with the second box 12 through the hinge group 21, and the upper hinge 21 and the lower hinge 22 of the hinge group 2 are mutually hinged together and respectively connected with the first box 11 and the second box 12 at the same time. When the first box 11 and the second box 12 are relatively unfolded or folded, the shaft rods 213 and 223 of the upper hinge 21 and the lower hinge 22 respectively move along the first movable groove 112 and the second movable groove 122 of the first box 11 and the second box 12, so as to achieve unfolding and folding actions of the first box 11 and the second box 12. When the first box 11 and the second box 12 are unfolded, the display screens 13 on the front surfaces of the first box and the second box can be used to display the scores of the competition. When the first box 11 and the second box 12 are folded together through the hinge group 2, the volume can be reduced, and storage and transportation are facilitated. The score board for the competition of the present disclosure can be used for scoring in various competitions. Compared with a traditional scoring manner by flipping the board, the present disclosure can omit a manual board flipping action, and make a scoring result more stable and reliable.

In this embodiment, the first mounting groove 111 of the first box 11 is provided with a first clamping buckle platform 113, the second mounting groove 121 of the second box 12 is provided with a second clamping buckle platform 123. The first clamping buckle platform 113 is used to limit the shaft rod 223 of the lower hinge 22, and the second clamping buckle platform 123 is used to limit the shaft rod 213 of the upper hinge 21. When the first box 11 is unfolded relative to the second box 12, the shaft rod 223 is clamped on the clamping buckle platform 113 to fix an unfolded state. The cooperation between the shaft rods 213 and 223 and the clamping buckle platforms 113 and 223 enables the present disclosure to eliminate the need for sliding or shifting again to remove a clamping point like a traditional clamping buckle, making it more convenient to use. Moreover, when a product needs to be unfolded, the cooperation between the shaft rods 213 and 223 and the clamping buckle platforms 113 and 223 can play a fixed role, so as to ensure that the first box 11 and the second box 12 are flat after unfolding.

Due to the need for power supply for the display screens, wiring is required. In order to facilitate wiring, the first box 11 and the second box 12 are internally and respectively provided with wiring spaces, and the upper hinge 21 and the lower hinge 22 are provided with receding grooves 214 and 224 for allowing electric wires to penetrate through, so as to achieve the function of hidden wiring.

In this embodiment, the upper hinge 21 and the lower hinge 22 have the same structure, and are preferably L-shaped structures with a first connecting plate 23 and a second connecting plate 24, the first shaft hole 211 of the upper hinge 21 and the first shaft hole 221 of the lower hinge 22 are formed in a connection between the first connecting plate 23 and the second connecting plate 24, and the second shaft hole 212 of the upper hinge 21 and the second shaft hole 222 of the lower hinge 22 are respectively formed at an end of the second connecting plate 24; and the shaft rod 213 of the upper hinge 21 and the shaft rod 223 of the lower hinge 22 are respectively disposed at an end of the first connecting plate 23. Preferably, the first connecting plate 23 and the second connecting plate 24 are disposed at an obtuse angle, a length of the first connecting plate 23 is greater than a length of the second connecting plate 24, and an included angle between the first connecting plate 23 and the second connecting plate 24 is in circular arc transition.

The present disclosure further discloses a hinge group, which is configured to connect a first box 11 with a second box 12, the hinge group 2 includes an upper hinge 21 and a lower hinge 22, the upper hinge 21 and the lower hinge 22 are respectively provided with first shaft holes 211 and 221, second shaft holes 212 and 222 and shaft rods 213 and 223, the first shaft holes 211 and 221 of the upper hinge 21 and the lower hinge 22 are mutually hinged together through a first rotating shaft 31, the second shaft hole 212 of the upper hinge 21 is hinged to the first box 11 through a second rotating shaft 32, the shaft rod 213 of the upper hinge 21 is slidably disposed on the second box 12, the second shaft hole 222 of a lower hinge 22 is hinged to the second box 12 through a third rotating shaft 33, and the shaft rod 223 of the lower hinge 22 is slidably disposed on the first box 12. A relative rotation connection between the first box 11 and the second box 12 can be achieved through cooperation of the upper hinge 21 and the lower hinge 22.

The upper hinge 21 and the lower hinge 22 have the same structure, and are preferably L-shaped structures with a first connecting plate 23 and a second connecting plate 24, the first shaft hole 211 of the upper hinge 21 and the first shaft hole 221 of the lower hinge 22 are formed in a connection between the first connecting plate 23 and the second connecting plate 24, and the second shaft hole 212 of the upper hinge 21 and the second shaft hole 222 of the lower hinge 22 are respectively formed at an end of the second connecting plate 24; and the shaft rod 213 of the upper hinge 21 and the shaft rod 223 of the lower hinge 22 are respectively disposed at an end of the first connecting plate 23. Preferably, the first connecting plate 23 and the second connecting plate 24 are disposed at an obtuse angle, a length of the first connecting plate 23 is greater than a length of the second connecting plate 24, and an included angle between the first connecting plate 23 and the second connecting plate 24 is in circular arc transition.

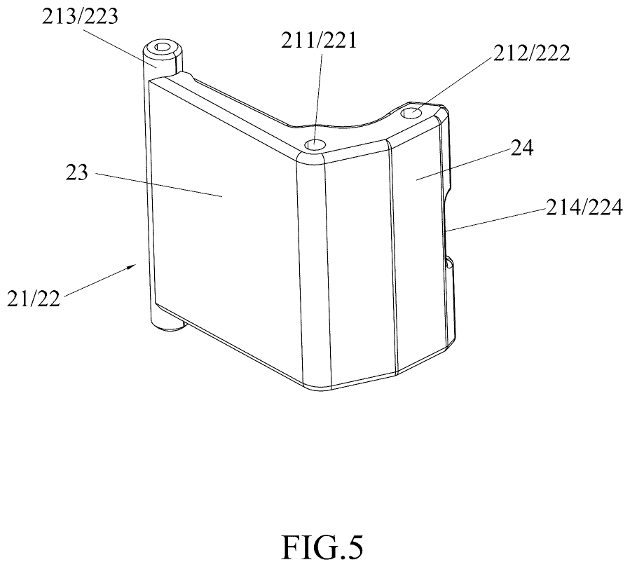

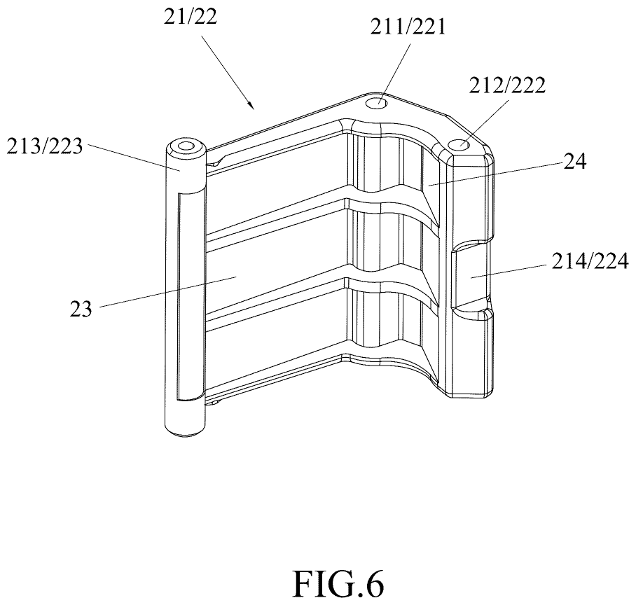

As shown in FIG. 5 and FIG. 6, the present disclosure further discloses a hinge, which has a first connecting plate 23 and a second connecting plate 24. The first connecting plate 23 and the second connecting plate 24 are L-shaped structures, and a connection between the first connecting plate 23 and the second connecting plate 24 is provided with first shaft holes 211 and 221, an end of the first connecting plate 23 is provided with shaft rods 213 and 223, and an end of the second connecting plate 24 is provided with second shaft holes 212 and 222. An included angle at the connection between the first connecting plate 23 and the second connecting plate 24 is preferably an obtuse angle, and the first connecting plate and the second connecting plate are in circular arc transition.

The above embodiments and drawings do not limit the product form and style of the present disclosure. Any appropriate changes or modifications made by ordinarily skilled in the relevant technical field should be regarded as not departing from the scope of the patent of the present disclosure.

1. A score board for a competition, comprising at least two boxes, wherein the two adjacent boxes are respectively connected through a hinge group, the two adjacent boxes comprise a first box and a second box, the hinge group comprises an upper hinge and a lower hinge, the upper hinge and the lower hinge are respectively provided with first shaft holes, second shaft holes and shaft rods, the first shaft holes of the upper hinge and the lower hinge are mutually hinged together through a first rotating shaft, the second shaft hole of the upper hinge is hinged to the first box through a second rotating shaft, the shaft rod of the upper hinge is slidably disposed on the second box, the second shaft hole of a lower hinge is hinged to the second box through a third rotating shaft, the shaft rod of the lower hinge is slidably disposed on the first box, a back surface of the first box is provided with a first mounting groove corresponding to the lower hinge, and the first mounting groove is internally provided with a first movable groove for allowing the shaft rod of the lower hinge to move; and a back surface of the second box is provided with a second mounting groove corresponding to the upper hinge, the second mounting groove is internally provided with a second movable groove for allowing the shaft rod of the upper hinge to move, and surfaces of the first box and the second box are provided with display screens.

2. The score board for the competition according to claim 1, wherein the first mounting groove of the first box is provided with a first clamping buckle platform for limiting the shaft rod of the lower hinge, and the second mounting groove of the second box is provided with a second clamping buckle platform for limiting the shaft rod of the upper hinge.

3. The score board for the competition according to claim 1, wherein the first box and the second box are internally and respectively provided with wiring spaces, and the upper hinge and the lower hinge are provided with receding grooves for allowing electric wires to penetrate through.

4. The score board for the competition according to claim 1, wherein the upper hinge and the lower hinge have the same structure, the upper hinge and the lower hinge are respectively L-shaped structures with a first connecting plate and a second connecting plate, the first shaft hole of the upper hinge and the first shaft hole of the lower hinge are formed in a connection between the first connecting plate and the second connecting plate, and the second shaft hole of the upper hinge and the second shaft hole of the lower hinge are respectively formed at an end of the second connecting plate; and the shaft rod of the upper hinge and the shaft rod of the lower hinge are respectively disposed at an end of the first connecting plate.

5. The score board for the competition according to claim 4, wherein the first connecting plate and the second connecting plate are disposed at an obtuse angle, a length of the first connecting plate is greater than a length of the second connecting plate, and an included angle between the first connecting plate and the second connecting plate is in circular arc transition.

6. A hinge group, configured to connect a first box with a second box, wherein the hinge group comprises an upper hinge and a lower hinge, the upper hinge and the lower hinge are respectively provided with first shaft holes, second shaft holes and shaft rods, the first shaft holes of the upper hinge and the lower hinge are mutually hinged together through a first rotating shaft, the second shaft hole of the upper hinge is hinged to the first box through a second rotating shaft, the shaft rod of the upper hinge is slidably disposed on the second box, the second shaft hole of a lower hinge is hinged to the second box through a third rotating shaft, and the shaft rod of the lower hinge is slidably disposed on the first box.

7. The hinge group according to claim 6, wherein the upper hinge and the lower hinge have the same structure, and are respectively L-shaped structures with a first connecting plate and a second connecting plate, the first shaft hole of the upper hinge and the first shaft hole of the lower hinge are formed in a connection between the first connecting plate and the second connecting plate, and the second shaft hole of the upper hinge and the second shaft hole of the lower hinge are respectively formed at an end of the second connecting plate; and the shaft rod of the upper hinge and the shaft rod of the lower hinge are respectively disposed at an end of the first connecting plate.

8. The hinge group according to claim 7, wherein the first connecting plate and the second connecting plate are disposed at an obtuse angle, a length of the first connecting plate is greater than a length of the second connecting plate, and an included angle between the first connecting plate and the second connecting plate is in circular arc transition.
